(19) United States
(12) Patent Application Publication
(10) Pub. No.: US 2026/0059128 A1
(43) Pub. Date: Feb. 26, 2026

(54) VIDEO COMPRESSION FOR BOTH MACHINE AND HUMAN CONSUMPTION USING A HYBRID FRAMEWORK

(71) Applicant: InterDigital VC Holdings, Inc., Wilmington, DE (US)

(72) Inventors: Fabien RACAPE, Los Altos, CA (US); Hyomin CHOI, Los Altos, CA (US); Syed Mateen UL HAQ, Los Altos, CA (US); Ujwal DINESHA, College Station, TX (US)

(21) Appl. No.: 19/105,397

(22) PCT Filed: Aug. 14, 2023
(86) PCT No.: PCT/US2023/030127

§ 371 Date: Feb. 21, 2025

Related U.S. Application Data
(60) Provisional application No. 63/403,463, filed on Sep. 2, 2022.

(51) Int. Cl. H04N 19/42; H04N 19/107; H04N 19/124; H04N 19/176; H04N 19/30; H04N 19/70; H04N 19/91

(52) U.S. Cl. CPC H04N 19/42; H04N 19/107; H04N 19/124; H04N 19/176; H04N 19/30; H04N 19/70; H04N 19/91

(57) ABSTRACT

In one implementation, we propose a scalable framework where a base layer uses NN-based methods to compress the content for computer vision machine tasks and enhancement layer(s) use traditional predictive coding for human viewing. Typically, the based layer performs NN-based analysis to generate a latent tensor, which is entropy coded to produce the base layer bitstream. By performing synthesis on the latent tensor, an inter-layer predictor can be obtained for the enhancement layer(s). Since many machine tasks are not required to be performed for each frame, the base layer may skip analysis for some frames. The synthesis may be performed at the base layer or the enhancement layer(s). In one example, the base layer compresses features optimized for a machine task and the enhancement layer(s) rely on predictive coding. In another example, the enhancement layer(s) can use traditional scalable video compression methods.

### TECHNICAL FIELD

The present embodiments generally relate to a method and an apparatus for compression of images and videos targeting both human and machine consumption.

### BACKGROUND

Traditional video compression standards can reach low bitrates by transforming and degrading the videos based on signal fidelity or visual quality. However, an increasing number of videos are now also “viewed” and analyzed by machines rather than humans, typically involving algorithms based on neural networks.

Optimizing existing video encoders directly for machine consumption is not trivial because of their handcrafted coding tools. The performance of Neural-Network (NN)-based computer vision algorithms may be impacted by the artifacts produced by classical codecs such as ringing, blocking artifacts and the loss of high spatial frequencies, as these artifacts were considered acceptable for the human vision system.

A new ad-hoc group at ISO/MPEG, called Video Coding for Machine (VCM), is working on the standardization of an efficient way of transmitting/storing compressed bitstreams which contain the necessary information for performing multiple tasks at the receiver, such as segmentation, object tracking, as well as reconstructing the videos for human viewing. In parallel, JPEG is standardizing JPEG-AI which is expected to become an end-to-end neural network-based image compression method that is also able to be optimized for machine tasks. Other standards and systems are likely to be envisioned in the future as use cases are already ubiquitous such as video surveillance, autonomous vehicles, smart cities etc.

### SUMMARY

According to one embodiment, a method of video encoding is provided, comprising: encoding an image with a neural-network based method to generate a first output; obtaining a first reconstructed version of said image corresponding to said first output; predicting a block of said image based on said first reconstructed version of said image to form a predicted block; and encoding said block based on said predicted block to generate a second output.

According to another embodiment, a method of video decoding is provided, comprising: entropy decoding a latent tensor corresponding an image; obtaining a first reconstructed version of said image based on said latent tensor, using a neural-network based method; predicting a block of said image based on said first reconstructed version of said image to form a predicted block; and decoding said block based on said predicted block to obtain a second reconstructed version of said image.

According to another embodiment, an apparatus for video encoding is provided, comprising one or more processors and at least one memory coupled to said one or more processors, wherein said one or more processors are configured to: obtain a first reconstructed version of said image corresponding to said first output; predict a block of said image based on said first reconstructed version of said image to form a predicted block; and encode said block based on said predicted block to generate a second output.

According to another embodiment, an apparatus for video decoding is provided, comprising one or more processors and at least one memory coupled to said one or more processors, wherein said one or more processors are configured to: entropy decode a latent tensor corresponding an image; obtain a first reconstructed version of said image based on said latent tensor, using a neural-network based method; predict a block of said image based on said first reconstructed version of said image to form a predicted block; and decode said block based on said predicted block to obtain a second reconstructed version of said image.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a scalable encoder using a hybrid NN-based base layer and a traditional prediction-based enhancement layer, according to an embodiment.

FIG. 3 illustrates a decoder supporting a base layer optimized for machine tasks and an enhancement layer reconstructing the input for viewing, according to an embodiment.

FIG. 4 illustrates a scalable video codec with a machine task NN-based base layer and a traditional enhancement layer using a hybrid scheme, according to an embodiment.

FIG. 5 illustrates interaction between the proposed base layer codec for machine and a standard scalable codec, according to an embodiment.

FIG. 6 illustrates a scalable encoder and decoder where the base layer decoder reconstructs the input, according to an embodiment.

FIG. 7 illustrates a scalable encoder and decoder including an upscaling stage enabling resolution scalability, according to an embodiment.

FIG. 8 illustrates a scalable codec with resolution scalability of a factor 2, according to an embodiment.

### DETAILED DESCRIPTION

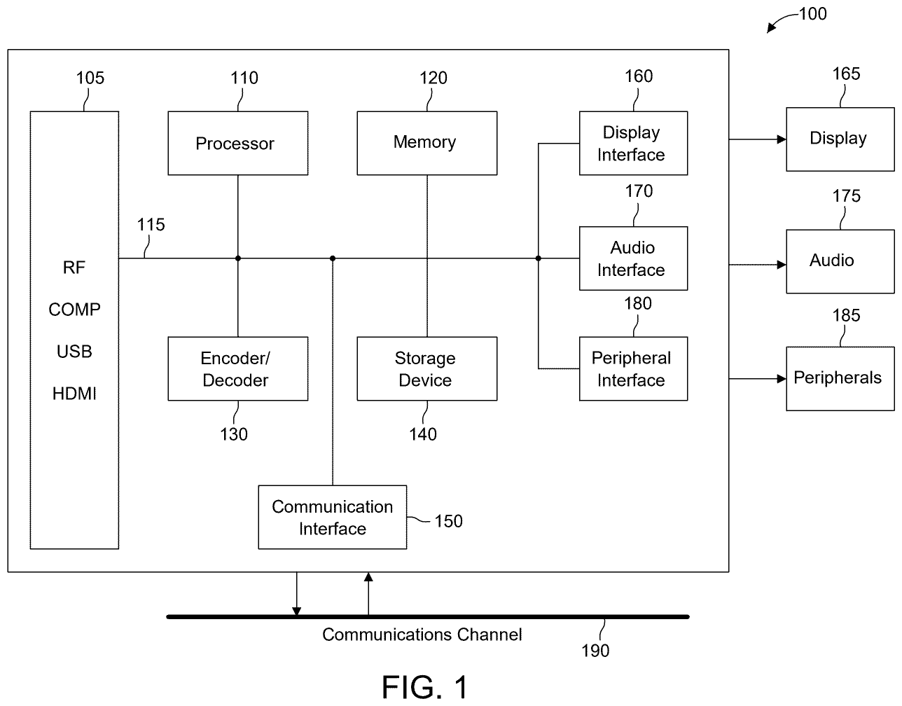

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, MPEG-4, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

In this application, we aim to optimize the compression of a bitstream including features dedicated for machine consumption as well as data for reconstructing the image or video frames for human viewing. For machine consumption only, NN-based codecs can be used to extract and compress the features for remote analysis. The advantage of using NN-based methods is that it is possible to train and optimize the system end-to-end, the compression trade-offs being controlled with respect to task accuracy-based losses. The reconstructed features at the decoder end can then be used as input for computer vision tasks. However, end-to-end compression methods are still challenging to design for efficient video compression for human consumption. Traditional methods are still more efficient both in terms of compression efficiency and complexity, i.e., memory consumption, energy, number of operations etc.

In addition, machine task algorithms may not need to be performed on every frame of a video. For instance, object detection or segmentation could be performed every 4 frames to save energy. However, reconstructing the video usually requires processing all or at least a subset of the frames to keep a satisfactory framerate for viewing, which is less flexible for computation adaptations and energy saving.

Some methods have been published where a scalable framework produces a bitstream that optimizes different layers for machine tasks or human consumptions. However, they use NN-based methods for each layer, including those for human consumption, hence keeping a very high computational complexity at both encoder and decoder sides.

In this application, it is proposed to design a hybrid framework with multiple types of outputs to support machine tasks and human consumption. Such framework is also called a scalable framework where a base layer uses NN-based methods to compress the content for computer vision machine tasks and at least one enhancement layer uses traditional scalable video compression methods to compress the content for human viewing. We call such a framework a scalable framework as a reconstructed image from the base layer can be used as a predictor for the enhancement layer. However, it should be noted that different from traditional temporal, spatial or quality scalable decoder that either targets a base layer output or an enhancement layer output, a decoder according to the proposed hybrid framework may output the base layer information and enhancement information simultaneously. It should also be noted that sometimes we mention the compression of images, however, the method applies to both images and videos.

In addition, like other scalable video compression methods, the proposed scheme is not limited to only one layer for machine tasks and one layer for human consumption, it can contain several layers optimized for different tasks and several layers for human consumption with different quality levels, spatial resolutions, temporal resolutions, etc.

Compression performance for a scalable framework in this context is evaluated in terms of bitrate versus reconstructed pixel distortion or bitrate versus machine-task accuracy compared to the case when input is individually compressed for the target task in each layer, also called multicast. This can be computed by measuring the total size of the bitstream containing all the layers in the scalable framework and evaluating the accuracy of the task performed for machine vision as well as quality metrics on the reconstructed image/video for human viewing.

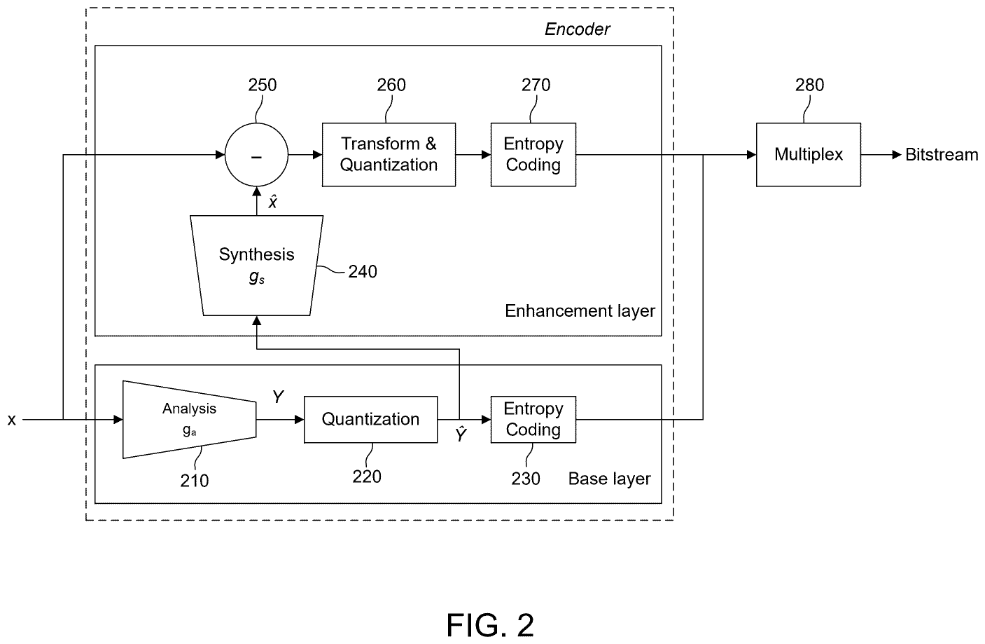

FIG. 2 shows an example of an encoder for the proposed scheme. In this example, the base layer uses a NN-based codec to perform the compression for machines, and the enhancement layer contains most of the basic operations of a traditional image codec such as JPEG, except that it can use the base layer as predictor.

In particular, the base layer takes the input image X as input. The compression method for the base layer can be composed of an analysis stage by compression analysis ga (210), which is generally composed of NN layers such as 2D convolutions and non-linear activations. This analysis produces computed latent elements (Y), usually in the shape of a 3D tensor composed of N latent channels with a lower spatial dimension than the input image as the convolutions used in the encoder generally involve downscaling. The latent elements Y can be deep feature maps if they are extracted to optimize for accuracy for the vision task. N is typically much larger than 3 (the 3 channels RGB of the input image), e.g., 128, 192, 256, 320, etc. The tensor Y is then quantized (220) to Ŷ, and entropy coded (230) to produce the bitstream corresponding to the base layer, which can be optimized with respect to bitrate and machine task accuracy. Note that the proposed method is not limited to the basic blocks of entropy coding and can include any advanced entropy modeling/transformations.

The mechanism of enhancement layer in traditional scalable codecs is based on predictions and residual, like temporal prediction in the context of video coding. An image, generated by synthesis gₛ (240), from the decoded base layer is used as predictor. Synthesis gₛ is generally composed of NN layers, such as transposed 2D convolution and non-linear activations. The difference (250) between the source image (X) and the predictor (\hat{X}), called residual, is then transformed and quantized (260) and entropy coded (270) to produce the bitstream which enables to reconstruct the original image. The bitstreams are then multiplexed (280) to form the scalable bitstream.

For reconstructing video frames, a synthesis module gₛ, is used to transform quantized latent tensor (Ŷ), to produce an image that can serve as predictor for the enhancement layer. However, compared to existing methods that aim at optimizing complex deep-autoencoders for both feature coding and image reconstruction simultaneously, it is proposed to re-use the compressed information from the base layer to synthesize frames that can be used as predictor for encoding an enhancement layer for human viewing, for example, using traditional predictive coding of an existing or future scalable video compression framework.

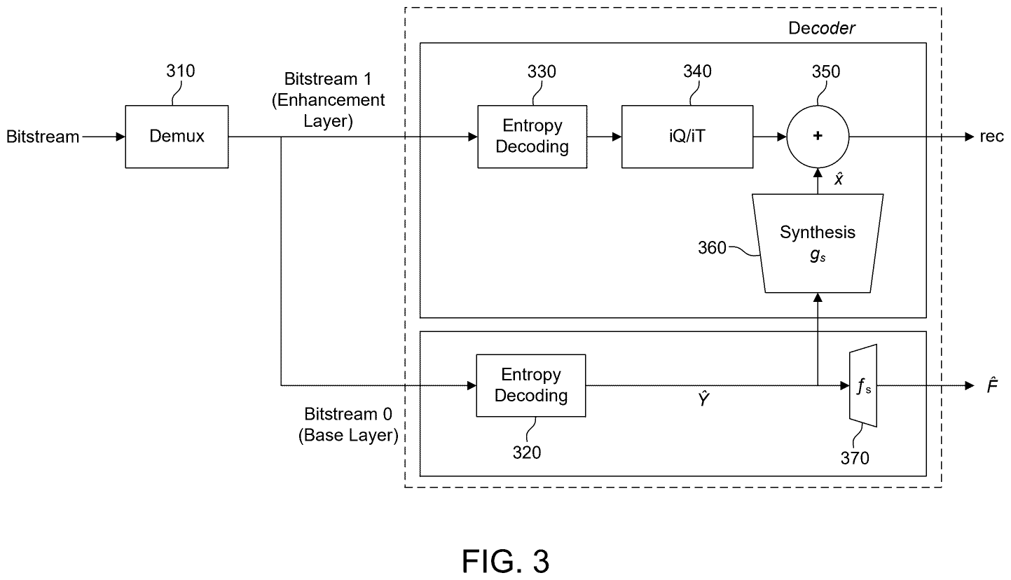

FIG. 3 shows a basic decoder architecture, according to an embodiment. The input bitstream is de-multiplexed (310) into bitstream 0 for the base layer and bitstream 1 for the enhancement layer. The first part of the bitstream (bitstream 0) is entropy decoded (320) to produce the reconstructed latent tensor Ŷ. The tensor Ŷ can be optionally processed by a feature synthesis ƒₛ (370) to produce the feature maps \hat{F} to be used for conducting machine task inference, in case the task algorithm expects features in a different shape than the compressed latent tensor Ŷ. ƒₛ can be trained towards optimal transforms for the task machine, whereas gₛ is trained towards producing a good predictor for the enhancement layer. For simplicity in the following, when a codec is illustrated, we provide examples where Ŷ is directly used as input by the machine task.

The second part of the bitstream (Bitstream 1) is first entropy decoded (330), then inversed quantized and inverse transforms (340) to reconstruct the residuals, which are added (350) to image \hat{X} generated by the synthesis gₛ (360) using the reconstructed latent tensor Ŷ as input. In the following, when a codec is illustrated, the multiplexing and de-multiplexing modules, and other communication processes between the encoder and decoder are skipped.

In this framework, the base layer can generally be trained end-to-end, relying on differential auto-encoders, or can be approximated by differentiable functions for training. Machine task algorithms also rely on differentiable neural networks which enable the system to be jointly optimized, updating the parameters of the auto-encoder and task algorithm by back-propagating gradients from a loss function relying on the task accuracy and the size of the compressed bitstream.

For the enhancement layer, gₛ aims at constructing frames that are good predictors to be used by the prediction system in the so-called traditional codec. gₛ can be trained using a loss criterion on the reconstructed \hat{X}, such as the MSE (Mean Squared Errors), but also l₀—norm as it is popular for generating efficient predictors in traditional video compression, since the goal is not to create a high-fidelity image with respect to the source, but to create a predictor which, added to a transmitted residual, leads to an efficient bitrate-distortion trade-off. Training gₛ can either be done separately from the base layer to not impact the performance of the compression versus task accuracy, by freezing the parameters of the encoder of the base layer, or jointly with the base layer, i.e., by using a composite loss function considering a weighted combination of the task accuracy, the reconstructed predictor, and the size of the base layer bitstream.

This framework has the advantage of being modular and flexible in terms of decoder complexity and use cases. The shape of the compressed latent tensor produced by NN-based auto-encoders generally corresponds to a 3D tensor of size

$$C \times \frac{H}{{2}^{n}} \times \frac{W}{{2}^{n}} ,$$

where C corresponds to the number of channels, H and W to the height and width of the input images, respectively, and n corresponds to the number of down sampling operations by a factor of 2 in the encoder, e.g., stride convolutions, pooling. Note that the base layer can also use block based end-to-end compression. In both cases, the reconstructed image \hat{X} can be used as a reference frame for predicting the enhancement layer.

One can think of synthesizing lower resolution of frames \hat{X}, since the channels of the latent tensor generally have a lower resolution, thus cutting some complex transposed 2D convolutions in gₛ at the decoder. The lighter resolution scalability features of scalable codecs can handle the upscaling and add appropriate residuals.

Moreover, deep features may not be needed at each time instant of the video sequence for the machine task, whereas all the frames may be required for a smooth display to human eyes. Instead of using computationally costly synthesis operations, intermediate frames for which no information from the base layer is available can be directly predicted temporally. Temporal scalability already exists in traditional scalable codecs. The frames of enhancement layers can be predicted using either temporal reference frames or frames coming from available lower layers. When the latter are not present, only temporal prediction is applied.

This application aims to provide methods to enable using compressed data from the base layer for the video reconstruction by at least one enhancement layer using traditional scalable video compression methods.

Compressing input content into bitstreams which are optimized for different machine tasks or for human consumption is widely studied. However, they always target an optimal transmission of the compressed data using differential auto-encoders for each task, including human viewing purpose. In this application, it is proposed to combine the use of a codec optimized for machine task, with a hybrid method that will add the necessary residual information to reconstruct the video for human consumption. In a way, the extracted features which are encoded for the machine task, will serve as a base layer, i.e., predictor, in a scalable video codec such as MPEG-4/SVC, its successor SHVC based on H.265/HEVC, or any other/future predictive methods.

To reference the data in the base layer in the context of predictive coding, it could be necessary for the decoder to reconstruct the pixels using the compressed data in the base layer, so that the enhancement layers of the scalable codec can refer to the reconstructed pixels as reference. In the following, different cases for the reconstruction are described in detail.

First, two use cases are described:
Case a: A new scalable compression system which includes a base layer for compressing features optimized for a machine task and an enhancement layer relying on traditional predictive coding for viewing.
Case b: The combination of a proposed coder for the base layer with an existing scalable video coding standard for the processing of the enhancement layer(s).

In the following, we consider the example with one (base) layer for machine task and one enhancement layer for viewing, but the proposed method is not limited to only one layer for each. One can extend the system to multiple enhancement layers targeting different machine tasks and/or multiple layers for viewing, e.g., different resolutions, quality levels, temporal resolutions etc.

### Case a

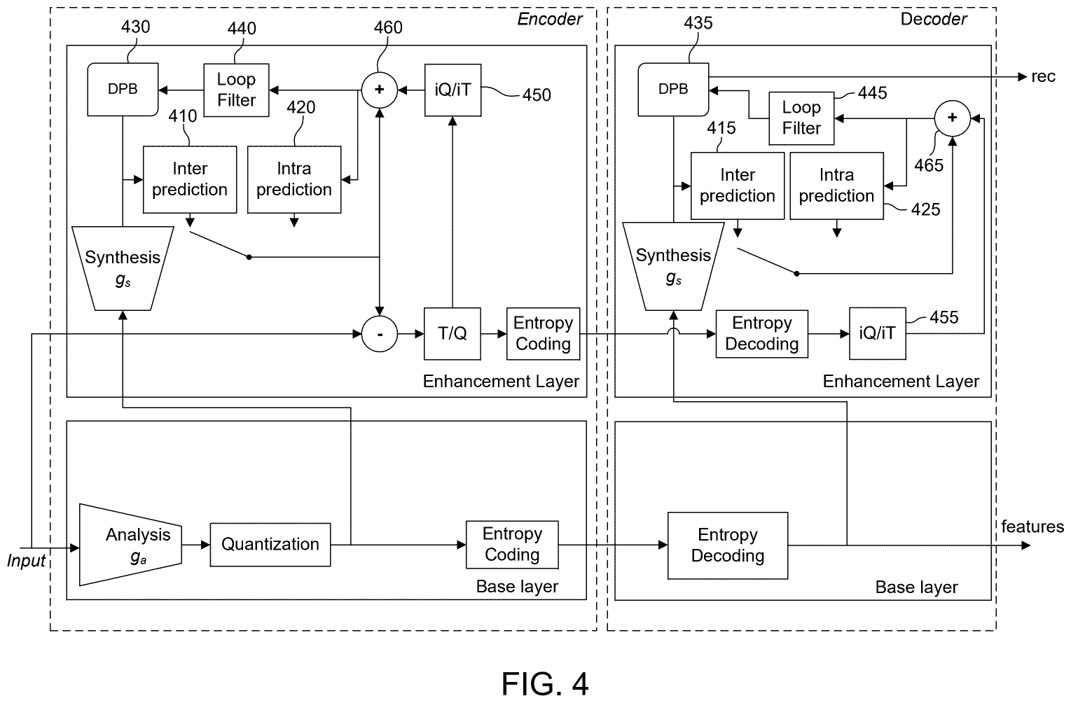

In this case, it is proposed to have a base layer including NN-based analysis for machine task. Like for H.265/SHVC, where the base layer can be decoded by any HEVC decoder, i.e., not containing scalable extensions, it is here possible for a “Video Coding for Machines” (VCM) encoder/decoder to process the base layer content independently. The reconstruction of a reference frame from the base layer to predict the enhancement layer would happen at the enhancement layer level, as depicted in FIG. 4.

To understand better the context of scalable video compression, FIG. 4 shows a scalable video codec, according to an embodiment. The base layer is unchanged compared to the previous figures. However, the enhancement layer now details the different options for prediction, including the selection of an intra frame prediction mode (420, 425) or an inter frame prediction mode (410, 415). For the inter frame prediction, the prediction can be temporal prediction or inter-layer prediction, wherein temporal prediction involves motion estimation referencing temporal pictures from the decoded picture buffer (DPB, 430, 435), and inter-layer prediction uses the generated predictor synthesized from the base layer, without encoding motion information. The encoder then selects the best predictor, for example, using Rate Distortion Optimization process. Note that the encoder now contains decoding modules. As illustrated in FIG. 4, both the encoder and decoder sides perform inverse transform and quantization (450, 455), as well as in-loop filters (LF, 440, 445) to be able to reconstruct (460, 465) and store reference images for temporal prediction. At the decoder, syntax elements are parsed from the bitstream, informing on which prediction modes are used as well as the reference pictures, temporal or base layer, to use.

For case a, the new system requires syntax for both base layer and enhancement layer processes as we modify the process of the enhancement layer which now includes the generation of gₛ.

### Case b

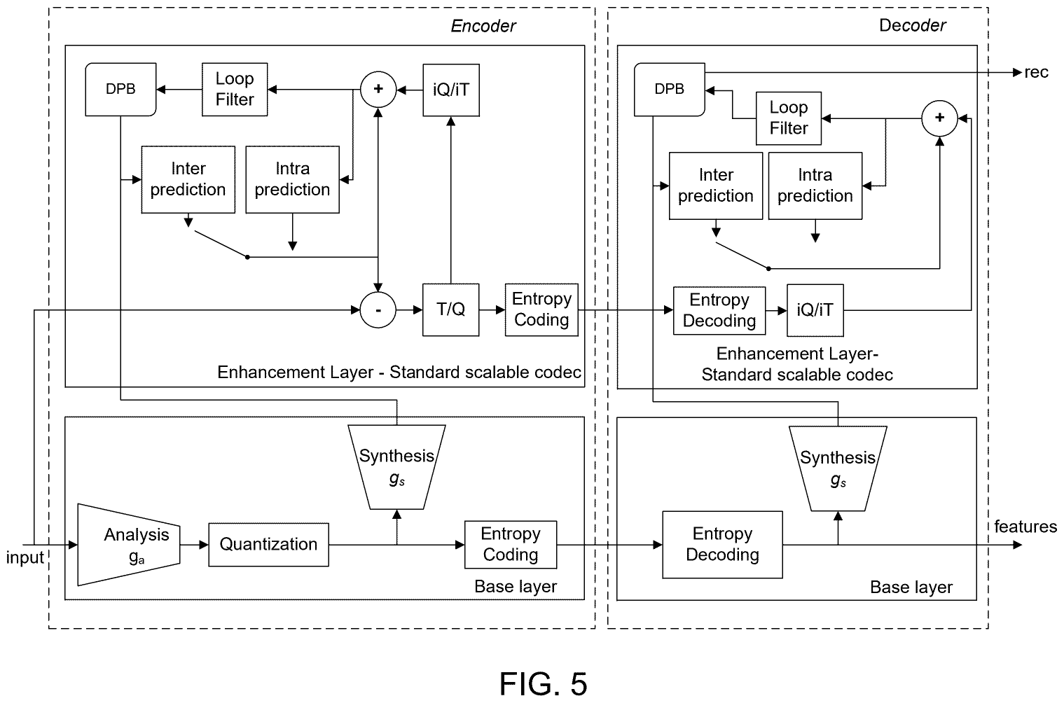

Compared with case a, the synthesis stage gₛ generating the reference frames from the base layer happens within the proposed codec at the base layer, so that the generated frames can be directly used by the existing scalable codec. In other words, we propose a new codec or an extension of a VCM codec that can be coupled with an existing traditional scalable video compression system. FIG. 5 shows a scheme where gₛ is now part of the base layer. The enhancement layer is used as is, taking the reference pictures generated by the base layer.

Here, we describe how the proposed method can interact with the existing syntax of traditional scalable codecs. We take the example of the scalability features of H.265/SHVC, described in annexes F and H of the specification of H.265/HEVC. Annex F specifies the High-Level syntax related to multi-layer bitstreams, i.e., multi-view, scalability, 3D. Annex H specifies the process of generating the reference pictures for compressing a current enhancement layer based on a previously decoded layer, i.e., with a lower id (nuh_layer_id).

In section 7.4.3.1, Video Parameter Set syntax elements vps_base_layer_internal_flag and vps_base_layer_available_flag are defined:
If vps_base_layer_internal_flag is equal to 1 and vps_base_layer_available_flag is equal to 1, the base layer is present in the bitstream.
Otherwise, if vps_base_layer_internal_flag is equal to 0 and vps_base_layer_available_flag is equal to 1, the base layer is provided by an external means not specified in this Specification.
Otherwise, if vps_base_layer_internal_flag is equal to 1 and vps_base_layer_available_flag is equal to 0, the base layer is not available (neither present in the bitstream nor provided by external means) but the VPS includes information of the base layer as if it were present in the bitstream.
Otherwise (vps_base_layer_internal_flag is equal to 0 and vps_base_layer_available_flag is equal to 0), the base layer is not available (neither present in the bitstream nor provided by external means) but the VPS includes information of the base layer as if it were provided by an external means not specified in this Specification.

In case b, the encoder can for instance set vps_base_layer_internal_flag=0 since our base layer is not encoded using HEVC and vps_base_layer_available_flag=1 since it is encoded using external means.

Then, section H.8.1.4 specifies the derivation process for inter-layer reference pictures, whether the inter-layer frame needs to be processed (upscaled, color transform, etc.) or not before being stored as reference.

Here, we take the example of H.265/HEVC syntax, however, the proposed method applies to any traditional multi-layer/scalable codec relying on predictive coding using reference frames from already reconstructed layers. In addition, while the codec is described based on VCM, the proposed methods are not limited to VCM and are applicable to other video codec platforms.

### Reconstruction Using Quality/SNR Scalability

In this embodiment, the decoder contains a synthesis stage that can reconstruct the frames from the reconstructed latent tensor (feature) at the desired resolution for the output video. In that case, which corresponds to FIG. 2 and FIG. 3, the reconstructed frames from the synthesis stage can be directly used as predictor for enhancement layer. This corresponds to the so-called SNR (Signal to Noise) scalability in traditional scalable codecs, i.e., when a base layer is encoded at a lower quality.

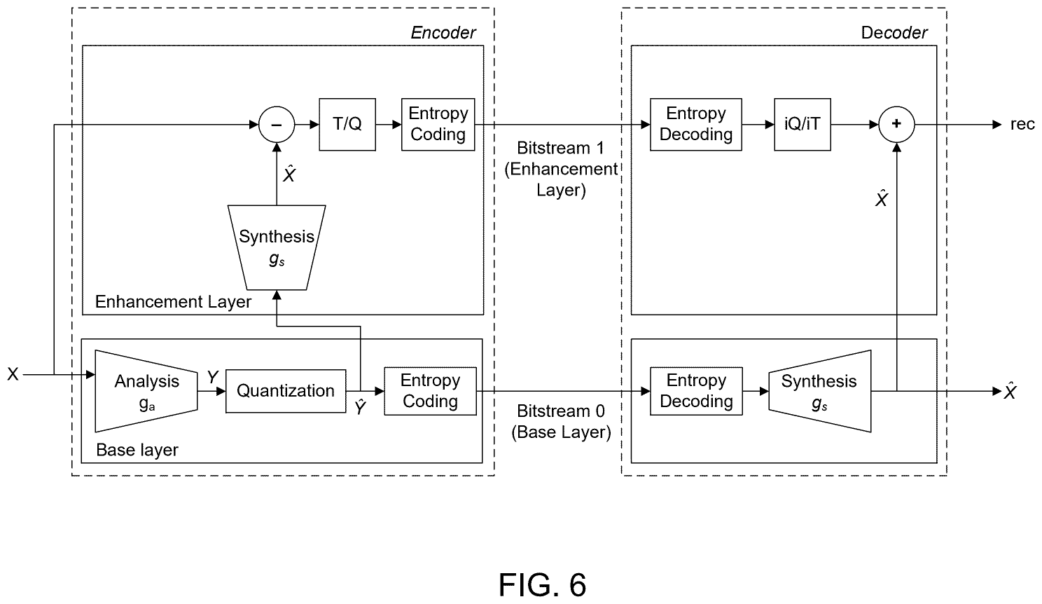

Some applications may require the compression system for the base layer to reconstruct images instead of generating the feature maps for machine vision network. Machine task designers, who trained their algorithms on datasets of videos or images, may need a compression system that lets them extract features on the receiver side. In that case, the base layer also includes gₛ that can be trained and optimized together with the encoder to reconstruct images optimized for machine tasks. In that case, a SNR scalable system enables to also reconstruct images for viewing (“rec” on FIG. 6), since the reconstructed base layer may contain severe artifacts for the human vision system that were acceptable with respect to the machine task accuracy, e.g., for image classification, low spatial frequencies or local features might be sufficient while not suitable for viewing. The reconstructed images by the base layer decoder can be directly used as reference for inter-layer prediction in the enhancement layer. Note that the encoder of the enhancement layer needs gₛ to derive and compress the necessary residuals to reconstruct images for viewing.

### Using Resolution Scalability

In this embodiment, it is preferred to reconstruct frames at a lower resolution from the synthesis module and use the resolution scalability module from the traditional scalable codec. This option can be useful when the decoder device is limited in deep-learning capabilities, such as graphic units for convolution layers for example, but includes a hardware implementation of a traditional scalable codec with its upscaling/downscaling separable filters.

The shape of the compressed latent tensor produced by NN-based auto-encoders generally corresponds to a 3D tensor of size

$$C \times \frac{H}{{2}^{n}} \times \frac{W}{{2}^{n}} ,$$

where C corresponds to the number of channels, H and W to the height and width of the input images, respectively, and n corresponds to the number of down sampling operations by a factor of 2 included in the encoder, e.g., stride convolutions, pooling.

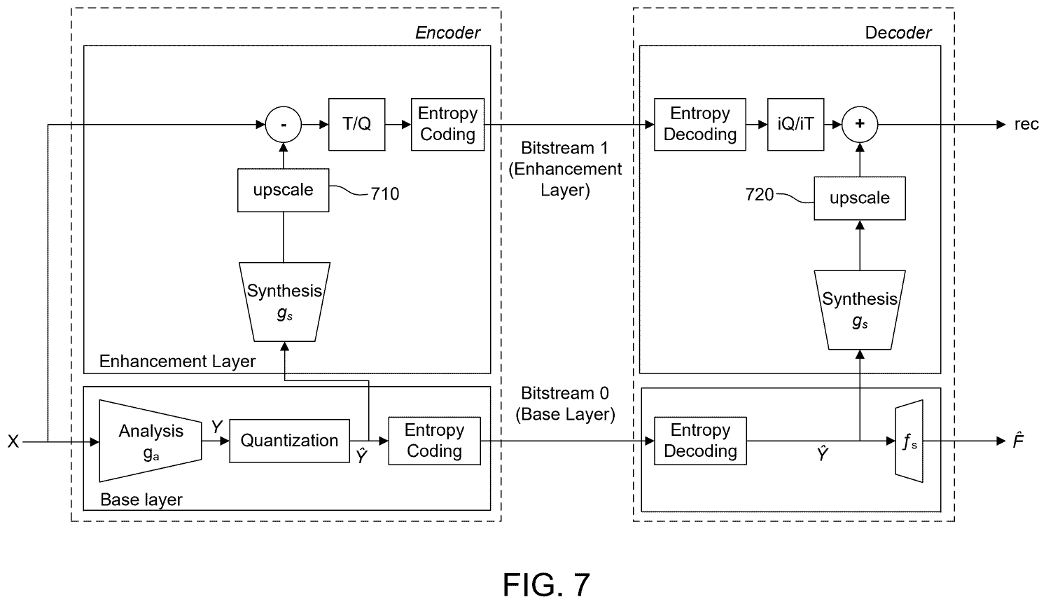

FIG. 7 describes a codec, according to an embodiment, where in addition to the modules described in FIG. 3, an upscaling process (710, 720) takes as input synthesized images with a resolution lower than X. Note that other processes can be added or replace the upscaling, e.g., bit-depth increase, color format conversions, resampling, etc.

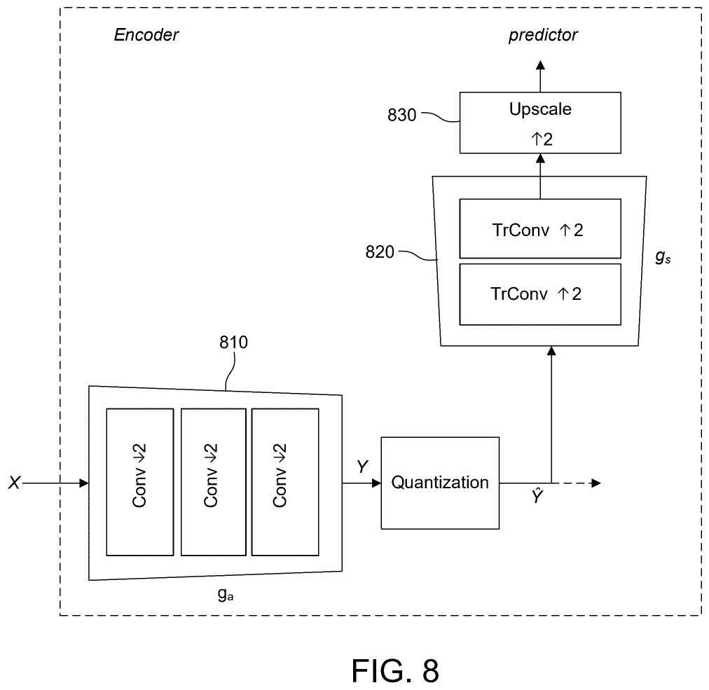

To provide a clearer example of the proposed resolution scalability, FIG. 8 shows a case where the encoder contains an analysis stage ga that includes 3 convolutions (810) with a stride of 2. The resulting latent tensor would have dimensions

$$C \times \frac{H}{8} \times \frac{W}{8} .$$

The codec can synthesize an image using a synthesis gₛ including only two transpose convolutions (820), the last one outputting a tensor of dimensions

$$3 \times \frac{H}{2} \times \frac{W}{2} ,$$

i.e., an image of lower dimension which can finally be up sampled (830) using the ad hoc tool from the scalable codec used to compress the enhancement layer.

Note that for training gₛ, we now use a criterion, e.g., MSE, versus a down sampled version of the input image, using the same filters as we use in the up-sampling process.

This extension is also compatible with case b where the synthesis happens in the codec compressing the base layer and producing reference frames for the scalable codec. In this case, the processing (upscaling, e.g., bit-depth increase, color format conversions, resampling, etc.) can still happen at the enhancement layer, i.e., within the traditional scalable codec.

### Dropping Frames at the Base Layer

Many computer vision tasks are not required to be performed at each frame of a video sequence. It is often possible to compute the necessary features every n frames, in particular when extracting the features with the analysis stage ga can be computationally intensive for low-end encoders.

The features are extracted for targeted frames which can still be used as base layer in the proposed model. Other frames are encoded in the enhancement layer without referencing the base layer as predictor. In terms of High-Level Syntax, no base layer predictor is added to the reference picture lists so that for a current frame, only the temporal pictures can be used for motion compensation.

In this embodiment, temporal scalability can be envisioned if the frames are dropped (no analysis is performed) corresponding to a regular period and the base layer would correspond to a lower framerate. Another syntax can also be used for an irregular temporal repartition of base layer processed frame, which would indicate inter-layer prediction only when the frames coming from the base layer are available.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, and inverse transformation. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method of video encoding, comprising:
encoding an image with a neural-network based method to generate a first output;
obtaining a first reconstructed version of said image corresponding to said first output;
predicting a block of said image based on said first reconstructed version of said image to form a predicted block; and
encoding said block based on said predicted block to generate a second output.

2. The method of claim 1, wherein said encoding to generate said first output comprises:
obtaining a latent tensor corresponding to said image based on said neural-network based method;
quantizing said latent tensor; and
entropy coding said quantized latent tensor to generate said first output.

3. The method of claim 2, wherein obtaining a first reconstructed version of said image comprises performing a second neural-network based method on said quantized latent tensor.

4-5. (canceled)

6. The method of claim 1, wherein encoding to generate said second output comprising:
selecting a prediction mode for said block, from intra prediction, temporal prediction and inter-layer prediction, wherein said predicting a block based on said first reconstructed version of said image is performed responsive to inter-layer prediction being selected.

7-9. (canceled)

10. The method of claim 1, wherein said image is from a video sequence, and wherein said encoding to generate said first output is performed for a first subset of images of said video sequence, and said encoding to generate a second output is performed for a second subset of images of said video sequence, wherein said second subset of images includes more images than said first subset of images.

11. (canceled)

12. A method of video decoding, comprising:
entropy decoding a latent tensor corresponding an image;
obtaining a first reconstructed version of said image based on said latent tensor, using a neural-network based method;
predicting a block of said image based on said first reconstructed version of said image to form a predicted block; and
decoding said block based on said predicted block to obtain a second reconstructed version of said image.

13. The method of claim 12, wherein obtaining a first reconstructed version of said image comprises performing a second neural-network method based on said latent tensor.

14. The method of claim 13, further comprising upscaling output from said second neural-network method to obtain said first reconstructed version of said image.

15-19. (canceled)

20. The method of claim 12, wherein said image is from a video sequence, and wherein said latent tensor is decoded for a first subset of images of said video sequence, and said second reconstructed version of said image is performed for a second subset of images of said video sequence, wherein said second subset of images includes more images than said first subset of images.

21. The method of claim 20, wherein a syntax element indicates that inter-layer prediction is only included when an image is available at a base layer.

22-24. (canceled)

25. An apparatus for video encoding, comprising one or more processors and at least one memory coupled to said one or more processors, wherein said one or more processors are configured to:
encode an image with a neural-network based method to generate a first output;
obtain a first reconstructed version of said image corresponding to said first output;
predict a block of said image based on said first reconstructed version of said image to form a predicted block; and
encode said block based on said predicted block to generate a second output.

26. The apparatus of claim 25, wherein said one or more processors are further configured to:
obtain a latent tensor corresponding to said image based on said neural-network based method;
quantize said latent tensor; and
entropy code said quantized latent tensor to generate said first output.

27. The apparatus of claim 26, wherein said one or more processors are configured to obtain a first reconstructed version of said image by performing a second neural-network based method on said quantized latent tensor.

28. The apparatus of claim 25, wherein said one or more processors are configured to:
select a prediction mode for said block, from intra prediction, temporal prediction and inter-layer prediction, wherein said predicting a block based on said first reconstructed version of said image is performed responsive to inter-layer prediction being selected.

29. The apparatus of claim 25, wherein said image is from a video sequence, and wherein said first output is generated for a first subset of images of said video sequence, and said second output is generated for a second subset of images of said video sequence, wherein said second subset of images includes more images than said first subset of images.

30. An apparatus for video decoding, comprising one or more processors and at least one memory coupled to said one or more processors, wherein said one or more processors are configured to:
entropy decode a latent tensor corresponding an image;
obtain a first reconstructed version of said image based on said latent tensor, using a neural-network based method;
predict a block of said image based on said first reconstructed version of said image to form a predicted block; and
decode said block based on said predicted block to obtain a second reconstructed version of said image.

31. The apparatus of claim 30, wherein obtaining a first reconstructed version of said image comprises performing a second neural-network method based on said latent tensor.

32. The apparatus of claim 31, wherein said one or more processors are further configured to upscale output from said second neural-network method to obtain said first reconstructed version of said image.

33. The apparatus of claim 30, wherein said image is from a video sequence, and wherein said latent tensor is decoded for a first subset of images of said video sequence, and said second reconstructed version of said image is performed for a second subset of images of said video sequence, wherein said second subset of images includes more images than said first subset of images.

34. The apparatus of claim 30, wherein a syntax element indicates that inter-layer prediction is only included when an image is available at a base layer.
